(19) United States
(12) Patent Application Publication
(10) Pub. No.: US 2025/0086468 A1
(43) Pub. Date: Mar. 13, 2025

(54) APPARATUSES, METHODS, AND COMPUTER PROGRAM PRODUCTS FOR DATA CONTEXTUALIZATION OF OPERATIONAL TECHNOLOGY ASSETS

(71) Applicant: Honeywell International Inc., Charlotte, NC (US)

(72) Inventors: Pavan Ravindra CHHATPAR, Atlanta, GA (US); Vijay Kumar RAVI, Atlanta, GA (US)

(21) Appl. No.: 18/466,232

(22) Filed: Sep. 13, 2023

(51) Int. Cl. G06N 3/09; G06N 3/098

(52) U.S. Cl. CPC G06N 3/09; G06N 3/098

(57) ABSTRACT

A method for classifying assets in a facility includes receiving item point metadata and time series data associated with an asset, applying a machine learning neural network to the item point metadata and time series data to determine a similarity between metadata associated with the asset and metadata associated with a known asset type, and determining that the asset is of the asset type based on the similarity satisfying a predetermined threshold. The neural network comprises anchor-based learning trained on a plurality of mined triplets including an anchor input, a positive input, and a negative input. The neural network is configured to generate vector representations associated with each of the anchor input, the positive input, and the negative input. A loss function applied to the vector representations is configured to differentiate between the vector representation associated with the positive input and the vector representation associated with the negative input.

### TECHNICAL FIELD

Various embodiments of the present disclosure relate generally to methods and systems for classifying assets in a facility, and, more particularly, to classifying assets in a facility using machine learning.

### BACKGROUND

Operational technology (OT) encompasses the use of hardware and software to monitor and control physical processes, devices, and infrastructure. Examples of OT includes building management systems (BMS), which are used across many industries to monitor assets (e.g., equipment, machinery, appliances, etc.). In a typical facility, a multitude of assets are connected over a network and send multiple signals containing various asset data to a central BMS. Generally, asset data is unstructured and not collected as a single, standard model, which leaves users to perform a substantial amount of manual work in order to maintain a useful and effective system. For example, users may have to manually, or using a secondary system, designate asset types for each asset based on metadata associated with the assets.

Outside the field of OT and BMS technologies, various machine learning schemes have been used to standardize unstructured data into classes. Typically, such machine learning involves determining the class of an unknown object based on the object's relationship to other objects of known classes (i.e. ground truth). However, these machine learning algorithms accept only binary ground truth labels of 1 or 0, indicating that a pair of objects are either a full positive or full negative pairs, respectively. In many practical applications, such as in OT and BMS technology, conventionally machine learning algorithms cannot adequately perform desired functionality. For example, various assets to be classified by OT and/or BMS may be of a class (i.e. asset type) for which no training data exists. Similar deficiencies exist in plants, facilities, and other environments. Furthermore, it would be beneficial to accept pairs that are partially positive or negative, i.e. having a label of a decimal value between 0 and 1.

The present disclosure is directed to overcoming one or more of these above-referenced challenges.

### SUMMARY OF THE DISCLOSURE

In some aspects, the techniques described herein relate to a method for classifying assets in a facility. In embodiments, the method includes receiving, by at least one processor, item point metadata and time series data associated with an asset. The method further includes applying, by at least one processor, a machine learning neural network to the item point metadata and time series data to determine a similarity between metadata associated with the asset and metadata associated with a known asset type. The method further includes determining, by at least one processor, that the asset is of the asset type based on the similarity satisfying a predetermined threshold. The machine learning neural network comprises anchor-based learning trained on a plurality of mined triplets each including an anchor input, a positive input, and a negative input. The machine learning neural network is configured to generate vector representations associated with each of the anchor input, the positive input, and the negative input. A loss function applied to the vector representations is configured to differentiate between the vector representation associated with the positive input and the vector representation associated with the negative input.

Other embodiments of the present disclosure are directed to a computer system for classifying assets in a facility. The computer system includes at least one memory having processor-readable instructions stored therein, and at least one processor configured to access the memory and execute the processor-readable instructions, which when executed by the processor configure the processor to perform a plurality of functions. The plurality of function include functions for receiving item point metadata and time series data associated with an asset, applying a machine learning neural network to the item point metadata and time series data to determine a similarity between metadata associated with the asset and metadata associated with a known asset type, and determining that the asset is of the asset type based on the similarity satisfying a predetermined threshold. The machine learning neural network comprises anchor-based learning trained on a plurality of mined triplets each including an anchor input, a positive input, and a negative input. The machine learning neural network is configured to generate vector representations associated with each of the anchor input, the positive input, and the negative input. A loss function applied to the vector representations is configured to differentiate between the vector representation associated with the positive input and the vector representation associated with the negative input.

Other embodiments of the present disclosure are directed to a non-transitory computer-readable medium containing instructions for classifying assets in a facility. The non-transitory computer-readable medium store instructions that, when executed by at least one processor, configure the at least one processor to perform receiving item point metadata and time series data associated with an asset, applying a machine learning neural network to the item point metadata and time series data to determine a similarity between metadata associated with the asset and metadata associated with a known asset type, and determining that the asset is of the asset type based on the similarity satisfying a predetermined threshold. The machine learning neural network comprises anchor-based learning trained on a plurality of mined triplets each including an anchor input, a positive input, and a negative input. The machine learning neural network is configured to generate vector representations associated with each of the anchor input, the positive input, and the negative input. A loss function applied to the vector representations is configured to differentiate between the vector representation associated with the positive input and the vector representation associated with the negative input.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for classifying assets in a facility, according to one or more embodiments.

FIG. 2 depicts an architecture for a machine learning neural network, according to one or more embodiments.

FIG. 3 depicts a table of exemplary triplets for a machine learning neural network for classifying assets in a facility, according to one or more embodiments.

FIG. 4 depicts an architecture for a machine learning neural network, according to one or more embodiments.

FIG. 5 depicts an architecture for a machine learning neural network, according to one or more embodiments.

FIG. 6 depicts a diagram of prediction workflow for a machine learning neural network, according one or more embodiments.

FIG. 7 depicts a flowchart of an exemplary method for classifying assets in a facility, according one or more embodiments.

FIG. 8 depicts a flowchart of an exemplary method for classifying assets in a facility, according one or more embodiments.

FIG. 9 depicts an implementation of a computer system that may execute techniques presented herein, according to one or more embodiments.

### DETAILED DESCRIPTION OF EMBODIMENTS

Various embodiments of the present disclosure relate generally to systems and methods for conceptualizing data in a building or facility, and more particularly, to systems and methods for classifying assets in a facility managed and or controlled by a building management system (BMS).

A BMS may be connected, via a wired or wireless network, to various assets, such as air handling units, chillers, fan coil units, electric meters, and other components of a facility. Each asset transmits signals to the BMS, which each signal containing metadata associated with that asset. It is common for the various assets connected to the BMS to communicate using different standards and/or protocols. This may be due to intermixing of assets from various manufacturers and of different ages or may simply be due to the absence of standardized communication protocols. As such, the data and metadata received by the BMS from the assets is largely unstructured and would conventionally by analyzed manually to categorize assets and develop a model of the facility.

The systems and methods of the present disclosure provide various machine learning architectures for automatically performing categorization of assets in order to improve efficiency of, and reduce reliance of manual labor, relative to conventional systems. In particular, the systems and methods of the present disclosure utilize machine learning neural networks including anchor-based and/or zero-shot learning to categorize assets by asset type based on metadata transmitted by the assets to the BMS.

Furthermore, the systems and method of the present disclosure provide an unconventional utilization of anchor-based and/or zero-shot learning in that similarity between points is not limited to a binary determination. Rather, similarity between points can be determined as a threshold, such as a percentage of overlap in the ground truth between points.

Subject matter will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended reflect or indicate that the embodiment(s) is/are “example” embodiment(s). Subject matter be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). Furthermore, the method presented in the drawings and the specification is not to be construed as limiting the order in which the individual steps may be performed. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” or “in some embodiments” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration. The execution of the machine-learning model may include deployment of one or more machine learning techniques, such as anchor-based learning or zero-shot learning.

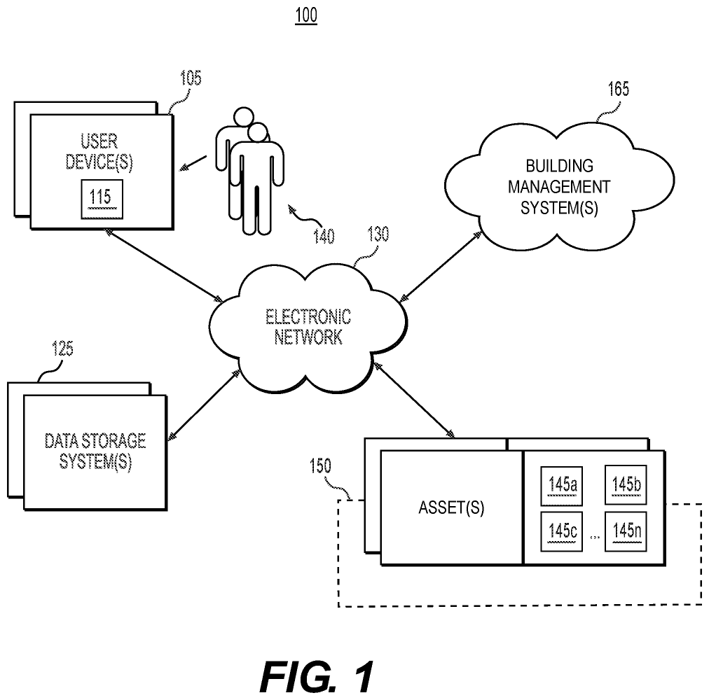

FIG. 1 depicts exemplary environment 100 that may be utilized with techniques presented herein. One or more user devices 105 used by one or more users 140 (e.g., an administrator of an internal data system), one or more data storage systems 125, one or more assets 145a-145n of facility 150, and one or more building management systems 165 may communicate across an electronic network 130. For example, communication between the various components of environment 100 may facilitate categorization of assets 145a-145n by asset type utilizing one or more machine learning models, as described herein. Further, environment 100 may be utilized to train such machine learning models using techniques such as triplet mining, as discussed herein.

In some embodiments, components of environment 100 are associated with a common entity, e.g., an employee/contractor administration system, or the like. In some embodiments, one or more of the components of environment 100 are associated with a different entity than another. As will be discussed herein, systems and/or devices of environment 100 may communicate in order to share and or query data between one another. As will be discussed herein, systems and/or devices of environment 100 may have various permissions with respect to one another.

One or more user device(s) 105 may include an input/output device (e.g., a touchscreen display, keyboard, monitor, etc.) associated with the user 140. User device 105 may be configured to enable user 140 to access and/or interact with other systems in the environment 100. For example, user device 105 may be a computer system such as, for example, a desktop computer, a server, a mobile device, a tablet, etc. In some embodiments, user device 105 may include one or more electronic application(s), e.g., a program, plugin, browser extension, etc., installed on a memory of user device 105. In some embodiments, the electronic application(s) may be associated with one or more of the other components in the environment 100. For example, the electronic application(s) may include one or more of system control software, system monitoring software, software development tools, etc. In some embodiments, user device(s) 105 may be configured to store and/or display model 115 including information relating to assets 145a-145n. Model 115 may be used to manage, monitor, maintain, and/or control assets 145a-145n automatically and/or with manual input from user 140.

Data storage system(s) 125 may include a server system, an electronic data system, computer-readable memory such as a hard drive, flash drive, disk, etc. In some embodiments, data storage system 125 includes and/or interacts with an application programming interface for exchanging data to other systems, e.g., one or more of the other components of the environment 100. Data storage system 125 may include and/or act as a repository or source for object data, user data, etc.

Assets 145a-145n may include any device, machine, apparatus, installation, etc. used within facility 150. Assets 145a-145n may include, for example, one or more air handling units, chillers, fan coil units, electric meters, and the like. Facility 150 may include, for example, a building, warehouse, jobsite, etc. In some embodiments, assets 145a-145n may include thousands of individual assets that must be controlled, monitored, and maintained. In some embodiments, assets 145a-145n may not all utilize a common or standard protocol. For example, individual assets from various manufacturers which do not share a standard communication protocols.

Building management system(s) 165 may include a system of hardware, software, firmware, and/or combinations thereof for managing, monitoring, maintaining, and controlling assets 145a-145n. In particular, building management system(s) 165 may be configured to generate a data model (e.g., model 115) mapping the assets 145a-145n of facility 150. Building management system(s) 165 may receive signals generated by assets 145a-145n over network 130. As noted above, assets 145a-145n may not share a common or standard communication protocol, resulting in building management system(s) 165 receiving an aggregation of unstructured data from the plurality of assets 145a-145n. The data transmitted to building management system(s) 165 from assets 145a-145n may include, for example, metadata from each asset 145a-145n from which a classifier for the respective asset, such as asset type, may be determined using the machine learning techniques described herein.

In various embodiments, electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

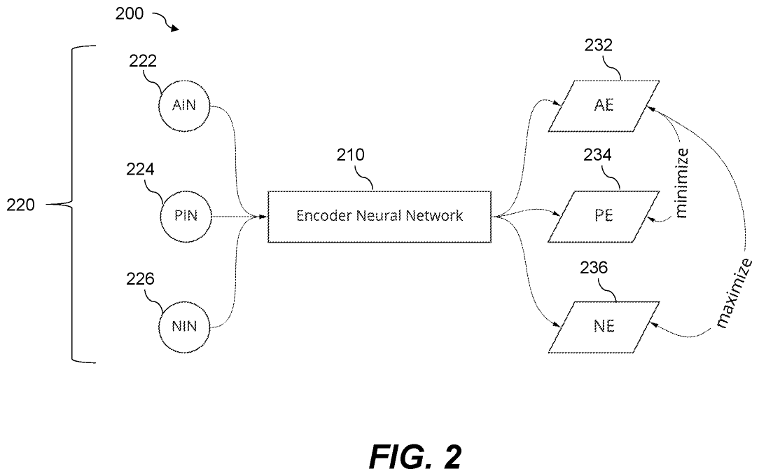

FIG. 2 depicts exemplary architecture 200 for a machine learning neural network in accordance with embodiments of the present disclosure. In some embodiments, the machine learning neural network may execute techniques such as anchor-based learning and, in some embodiments, zero shot learning. As described herein, architecture 200 may be utilized to categorize asset types in a building management system (e.g., building management system 165 of environment 100 of FIG. 1). That is, architecture 200 may be utilized to determine asset type data from metadata received by the building management system (e.g., building management system 165 of FIG. 1) from various assets within a facility (e.g., assets 145a-145n of facility 150 of FIG. 1). Architecture 200 includes an encoder neural network 210 configured to transform a triplet 220, including anchor input (AIN) 222, positive input (PIN) 224 and negative input (NIN) 226, into embeddings 232, 234, 236. Each of anchor input 222, positive input 224, and negative input 226 may include respective item point descriptions and time series data associated with the asset. Embeddings 232, 234, 236 may be mapped as vector representations to determine the similarity of assets associated with AIN 222, PIN 224, and NIN 226. In order to train encoder neural network 210, triplet 220 may include known data for AIN 222, PIN 224, and NIN 226. For example, AIN 222 includes a sample of a known class (e.g. asset type). Positive input 224 includes a sample known to be of the same class (e.g. asset type) as anchor input 222. Negative input 226 includes a sample of a different class (e.g. asset type) than anchor input 222 (and thus also a different class than positive input 224). Based on properties (e.g., metadata) of inputs 222, 224, 226, encoder neural network 210 generates outputs, i.e. embeddings 232, 234, 236, associated with each of inputs 222, 224, 226 based on how closely each of positive input 224 and negative input 226 is associated to anchor input 222. Embeddings 234, 236 include vector representations mapped to a vector space to facilitate determination of a similarity (e.g., cosine distance) to embedding 232 associated with anchor input 222.

Assuming encoding neural network effectively generates embeddings 232, 234, 236, the distance between positive embedding 234 and anchor embedding 232 is less than the distance between negative embedding 236 and anchor embedding 232. That is, the distance between positive embedding 234 and anchor embedding 232 is minimized (due to the similarity of asset type) and the distance between negative embedding 236 and anchor embedding 232 is maximized (due to dissimilarity of asset type. In this manner, architecture 200 can be used to effectively differentiate between assets, represented by positive and negative inputs 224, 226, based on the distance between positive and negative embeddings 234, 236 and anchor embedding 232.

By providing encoder neural network 210 with a plurality of inputs, both positive and negative, encoder neural network 210 can be trained to maximize the differentiation between positive embeddings and negative embeddings in vector space. That is, the probability of encoder neural network 210 generating a false positive (i.e., incorrectly determining a positive relationship between a negative embedding and an anchor embedding) or a false negative (i.e., incorrectly determining a negative relationship between a positive embedding and an anchor embedding) is reduced through effective training. In particular, encoder neural network 210 may be trained using “hard” cases—i.e. cases in which NIN 226 is similar to PIN 224—so that encoder neural network 210 is forced to differentiate between similar but different input, ultimately making encoder neural network 210 more robust.

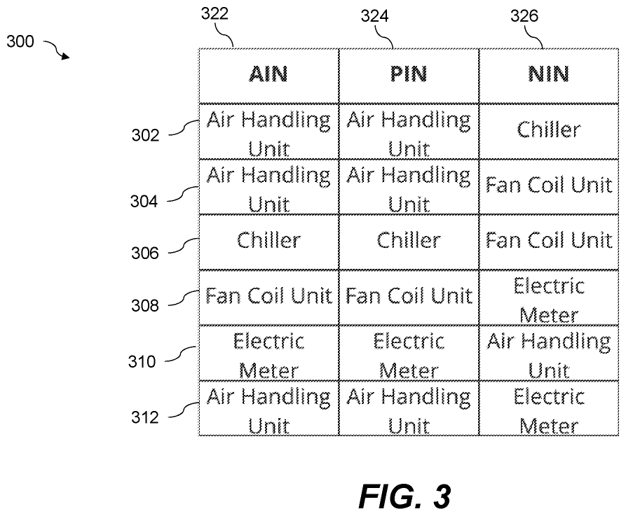

FIG. 3 depicts a table 300 including exemplary values for inputs, in the form of particular asset types, into encoder neural network 210. Each row 302-312 of table 300 represents a triplet including an anchor input (in column 322), and positive input (in column 324), and a negative input (in column 326). For example, the triplet of row 302 includes anchor input of “Air Handling Unit”, positive input of “Air Handling Unit”, and negative input of “Chiller”. As is readily apparent, the anchor input and the positive input are of the same asset type, namely “Air Handling Unit”, whereas the negative input is a different asset type, namely “Chiller”. Similarly, the triplet of row 304 includes anchor input of “Air Handling Unit”, positive input of “Air Handling Unit”, and negative input of “Fan Coil Unit”; and so on for remaining rows 306-312 of table 300.

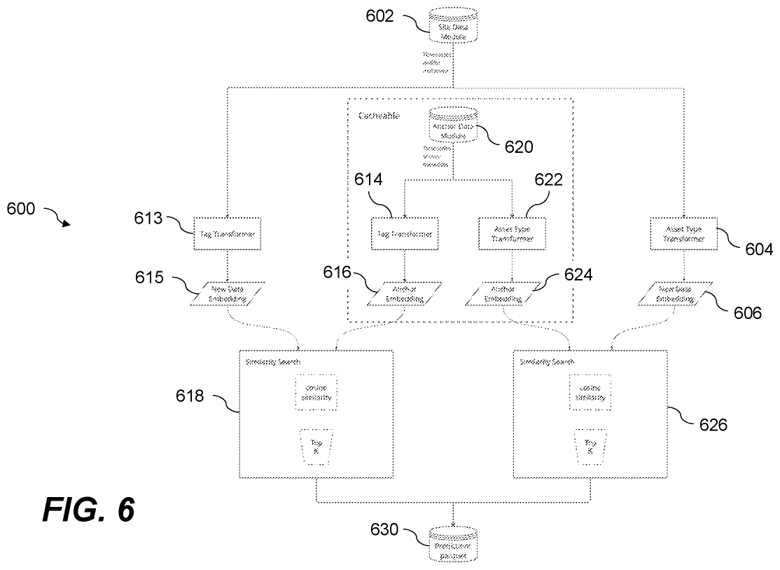

Each triplet can be mapped to a vector space using a machine learning neural network (such as encoder neural network 210 of FIG. 2) based on metadata associated with the underlying asset (i.e. metadata relating to the Air Handling Unit, Chiller, etc.). From these mappings, a first distance between the anchor input and the positive input, and a second distance between the anchor input and the negative input. In particular, the first distance between the anchor input and positive input is less than the second distance between the anchor input and the negative input. As such, a prediction workflow (e.g., prediction workflow 600 of FIG. 6) applied to embeddings generated by the neural network can distinguish between the positive input and negative input of the triplet.

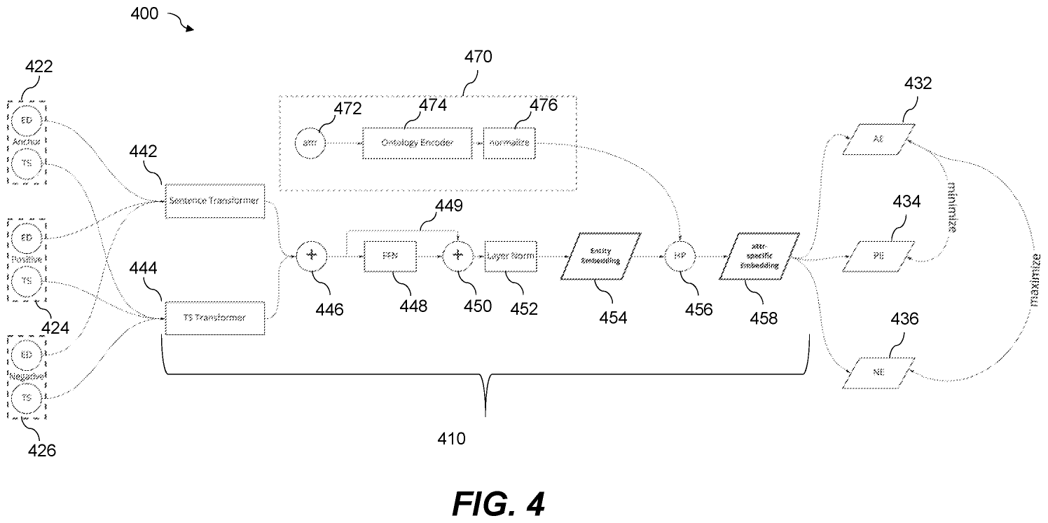

Referring now to FIG. 4, expanded architecture 400 for a machine learning neural network in accordance with embodiments of the present disclosure is illustrated. As described herein, architecture 400 may be utilized to categorize asset types in a building management system (e.g., the building management system 165 of FIG. 1). As in architecture 200 of FIG. 2, architecture 400 includes an encoder neural network 410 that receives a triplet input including anchor input 422, positive input 424, and negative input 426. Each of anchor input 422, positive input 424, and negative input 426 includes respective item point descriptions (ED) and time series data (TS) associated with an asset. Encoder neural network 410 includes one or more transformers 442, 444 which receive and transform inputs 422, 424, 426. Transformers 442, 444 may be used to convert raw data from inputs 422, 424, 426 into formats suitable for encoder neural network 410. For example, transformers 442, 444 may transform data from inputs 422, 424, 426 into numerical values (i.e. real numbers) that may be mapped to a vector space. In the illustrated embodiments, these transformers include sentence transformer 442 and time series transformer 444. Entity description data (ED) of each input 422, 424, and 426 is transformed by sentence transformer 442, and time series sensor data (TS) of each input 422, 424, and 426 is transformed by time series transformer 444.

Referring still to FIG. 4, a vector addition operation 446 is applied to the transformer output data from transformers 442, 444, and the result of operation 446 is transmitted to feedforward neural network (FFN) 448. FFN 448 receives the transformer output data 446 and, from that data, generates FFN output data on which an operation 450 is performed. FFN output data, after operation 450 is performed, is then received by layer normalization module 452, which normalizes FFN output data 450 and transmits the result of layer normalization to entity embedding module 454. Entity embedding module 454 generates a plurality of vector representations of FFN output data after being normalized by layer normalization module 452. The number of vector representations generated by entity embedding module 454 may be equal to a number of classifications (e.g., 8 classifier types) associated with asset type. In particular, each vector representation generated by entity embedding module 454 may be mapped to a specific area associated with one of the classifier types.

Referring still to FIG. 4, architecture 400 further includes ontology 470 configured to generate vector representation(s) associated with assets (e.g., assets 145a-145n) connected to a building management system (e.g., building management system 165 of FIG. 1). In some embodiments, ontology 470 may have a plurality of point roles (for example, on a magnitude of hundreds of point roles) each applicable to one or more assets from a predefined list of asset type (e.g. air handling unit, chiller, fan cool unit, electric meter, etc.). Ontology 470 includes attribute data 472 associated with the assets, which is fed into ontology encoder 474. Ontology encoder 474 generates vector representations based on the attribute data 472 associated with the assets. In particular, ontology encoder 474 may generate a number of vector representations equal to a number of classifications (e.g., 8 classifier types) associated with asset type. Each vector representation generated by ontology encoder 474 may be mapped to a specific area associated with one of the classifier types. The output (i.e. vector representations) generated by ontology encoder 474 are then normalized by normalizer 476 so as to be compatible with the outputs of entity embedding module 454.

Referring still to FIG. 4, architecture 400 further includes Hadamard product operator (HP) 456 that combines the output of entity embedding module 454 and normalizer 476. HP 456 generates an element-wise product based on the outputs of entity embedding module 454 and normalizer 476, thereby generating a plurality of vector representations, each corresponding to one of the classifications associated with asset type. In some embodiments, each vector representation generated by HP 456 for each point may be optimized for one of eight (8) different classifier types (i.e., the same number of vector representations generated by entity embedding module 454 and normalizer 476). That is, HP 456 may generate eight different vector representations for each point, each vector representation being optimized for one of each of the classifier types. Thus, encoder neural network 410 handles all eight classifier types itself, whereas conventional machine learning architectures utilize a different neural network for each classifier type. As such, encoder neural network 410 saves computational resources and improves efficiency of architecture 400 relative to conventional machine learning techniques.

Referring still to FIG. 4, architecture 400 further includes attribute-specific embedding module 458, which receives the output of HP 456 and generates embeddings 432, 434, 436. Embeddings 432, 434, 436 may correspond to embeddings 232, 234, 236 of FIG. 2. As such, positive embedding 434 may represent a positive embedding associated with input 424, and negative embedding 436 may represent a negative embedding associated with input 426. A distance (e.g., cosine distance) between positive embedding 434 and anchor embedding 432 is less than a distance (e.g., cosine distance) between negative embedding 436 and anchor embedding 432, such that a loss function can differentiate between positive and negative embeddings 434, 436.

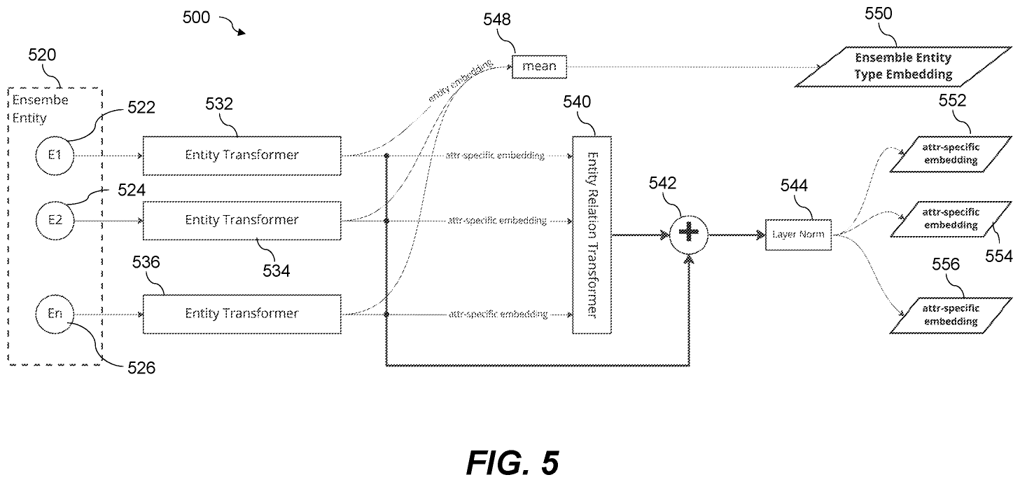

Referring now to FIG. 5, architecture 500 for a machine learning neural network in accordance with embodiments of the present disclosure is illustrated. Architecture 500 utilized entity type embedding, which in some embodiments may improve efficiency of the underlying machine learning algorithms. Architecture 500 may be similar in functionality to architecture 400, with the primary difference being that architecture 500 utilizes an ensemble model. The ensemble model works by combining two or more modeling techniques. In some embodiments, the two or more modeling techniques include two sentence transformer models. Here, an ensemble represents a collection of points so that the ensemble model is able to improve learning by learning from all points of an asset together compared to learning from points individually. Architecture 500 may particularly utilized entity embeddings 454 of architecture 400 of FIG. 4, which are being processed together via operator mean 548. Particularly, because entity embedding module 454 of architecture 400 does not necessarily take attribute name (or attribute data) into account (i.e., attribute data 472 is not introduced into the embeddings until a Hadamard product is generated by HP 456), entity embedding module 454 is suitable for entity type embedding. That is, the attribute name (or data) is only used for predicting a certain attribute of the point. Entity type, by contrast, is for the whole asset and includes all points and all attributes of the points for that asset. Hence, the attribute name is not needed for further distinguishing.

Architecture 500 includes ensemble entity 520 including a triplet input 522, 524, 526. Similar to inputs 422, 424, 426 of architecture 400, each of inputs 522, 524, 526 includes item point description and time series data associated with an asset. Further, each of in inputs 522, 524, and 526 of architecture 500 includes asset name as an additional parameter. Asset name is used to group inputs 522, 524, 526 into ensemble entity 520 (i.e., each of inputs 522, 524, 526 has a matching asset name). Each of inputs 522, 524, 526 is processed by a respective entity transformer 532, 534, 536 to generate an entity embedding and an attribute-specific embedding respectively associated with each of inputs 522, 524, 526. Output from entity transformers 532, 534, 536 is transmitted to entity relation transformer 540 which processes correlations between the attribute-specific embeddings (e.g., similar names, lagged and/or synchronized sensor values, etc.). The output of entity relation transformer 540 is transmitted to operator 542, which is a residual connection given to ensure that the gradients do not vanish. After undergoing operation 542, the output data is subsequently normalized by layer normalization module 544. Layer normalization module 544 in turn generates attribute-specific embeddings 552, 554, 556.

In parallel with processing by entity relation transformer 540, output from entity transformers 532, 534, 536 is also transmitted to ensemble entity type embedding module 550 via mean 548 to generate additional embeddings. Mean 548 may be a standard mean (average) vector operation. The ensemble entity type is one of the prediction outputs that the model provides, and then the prediction is used to predict further point roles.

Referring now to FIG. 6, a diagram of exemplary prediction workflow 600 for a machine learning neural network (e.g., the neural networks of FIGS. 2, 4, and/or 5) is illustrated in accordance with an embodiment of the present disclosure. In the illustrated example, prediction workflow 600 utilizes a similarity search algorithm to categorize asset(s) in a facility (e.g., assets 145a-145n of facility 150 of environment 100). Prediction workflow 600 receives input data 602 (e.g., time series data and item point metadata such as description data and point name data) and sends such input data 602 to one or more appropriate transformers. Ultimately, input data 602 is processed against anchor data 620 to determine similarity of the data, and ultimately to categorize one or more assets (e.g., assets 145a-145n of environment 100). For example, point name data may be sent to first asset type transformer 604 to generate new data embeddings 606. Anchor data 620 may be sent to second asset type transformer 622 to generate anchor embeddings 624 for comparison with new data embeddings 606. New data embeddings 606 and anchor embeddings 624 are processed by similarity search module 626 to determine a cosine similarity, a top-k classification, and/or other metric to determine similarity of new data embeddings 606 relative to anchor embeddings 624.

Additionally, input data 602 (including time series data and item point metadata such as description data) may be sent to first tag transformer 613 to generate new data embeddings 615. Second tag transformer 614 receives anchor data 620 (e.g., anchor time series data and anchor item description metadata) and generates anchor embeddings 616 from anchor data 620. New data embeddings 615 and anchor embeddings 616 are processed by similarity search module 618 to determine a cosine similarity, a top-k classification, and/or other metric to determine similarity of new data embeddings 606 relative to anchor embeddings 624.

New data embeddings 606, 615 represent data from the site (e.g. facility 150 of FIG. 1) being used for prediction. Determination of anchor embeddings 616, 624 is cacheable in that embeddings 616, 624 generated from anchor data 620 can be stored in computer-readable memory and re-used as needed, such as during future iterations of loss function 600.

Results of similarity search modules 618, 624 are stored as predictions parquet 630.

As noted above, loss function 600 may be utilized to determine the asset type of asset of a facility (e.g., any of assets 145a-145n of facility 150 of environment 100 of FIG. 1). Specifically, inputs 602 may include data transmitted from an asset to a building management system (e.g. building management system 165 of environment 100) or other operational technology.

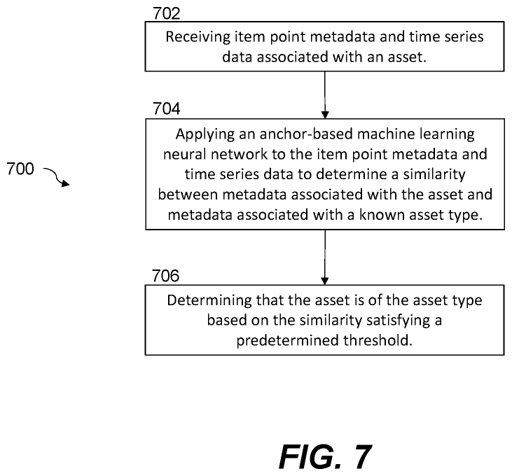

Referring now to FIG. 7, illustrated is a flow diagram of method 700 for classifying assets in a facility, such as assets 145a-145n of facility 150 of environment 100 (see FIG. 1). Each of steps 702-706 of method 700 may be performed automatically by at least one processor, such as included in controller 900, associated with a component of environment 100, such as user device(s) 105, data storage system 125, and/or building management system(s) 165.

With continued reference to FIG. 7, method 700 includes, at step 702, receiving item point metadata and time series data associated with an asset, such as one or more of assets 145a-145n of FIG. 1. The item point metadata may include, for example, item point description, units of measure, limits, and other information associated with the asset(s).

With continued reference to FIG. 7, method 700 includes, at step 704, applying a machine learning neural network to the item point metadata and time series data to determine a similarity between metadata associated with the asset and metadata associated with a known asset type. The machine learning neural network may utilize anchor-based learning trained on a plurality of mined triplets each including an anchor input, a positive input, and a negative input, as described herein in connection with FIGS. 2-5. In particular, the machine learning neural network is configured to generate vector representations associated with each of the anchor input, the positive input, and the negative input. A loss function (e.g., prediction workflow 600 of FIG. 6) applied to the vector representations is configured to differentiate between the vector representation associated with the positive input and the vector representation associated with the negative input.

As described above in connection with FIGS. 2-6, categorization of the assets may present a multiclass classification problem. For example, eight (8) different classifier types may be utilized, resulting in eight (8) vector representations being generated by the machine learning neural network. As described herein, a single neural network (e.g., encoder neural network 410 of architecture 400) may generate the vector representations associated with all eight classifier types. The similarity determined at step 704 may be based, for example, on the similarity (e.g., cosine distance) between the vector representation of the asset and the vector representation of the asset of a known type.

With continued reference to FIG. 7, method 700 includes, at step 706, determining that the asset is of the asset type based on the similarity satisfying a predetermined threshold. The predetermined threshold may represent a percentage of metadata between the asset and an asset of known type to positively determine the type of the asset (e.g., air handling unit, chiller, fan coil unit, electric meter, or the like). For example, an asset may be determined to be of a particular asset if the asset overlaps at least about 20%, at least about 30%, at least about 40%, at least about 50% of metadata with that of an asset of known type. Thus, determination of asset type need not be a binary determination, as in determinations made by conventional anchor-based machine learning algorithms.

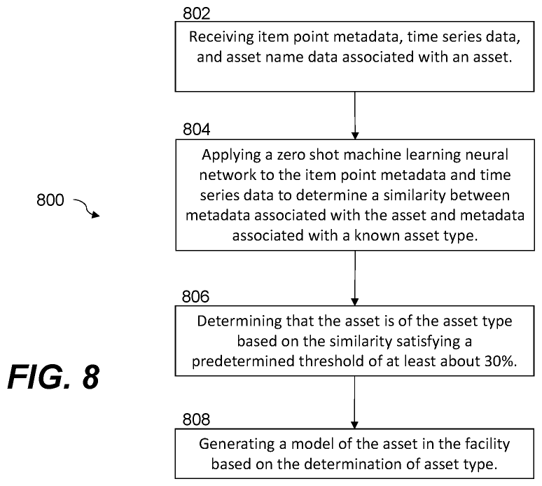

Referring now to FIG. 8, illustrated is a flow diagram of method 800 for classifying assets in a facility, such as assets 145a-145n of facility 150 of FIG. 1. Each of steps 802-808 of method 800 may be performed automatically by at least one processor, such as included in controller 900, associated with a component of environment 100, such as user device(s) 105, data storage system 125, and/or building management system(s) 165.

With continued reference to FIG. 8, method 800 includes, at step 802, receiving item point metadata associated with an asset, such as one or more of assets 145a-145n of FIG. 1, substantially similar to step 702 of method 700. Step 802 further includes receiving asset name data associated with the asset. The asset name data may be used, for example, to improve efficiency of an applied machine learning neural network as describe in connection with the ensemble model of architecture 500 of FIG. 5.

With continued reference to FIG. 8, method 800 includes, at step 804, applying a machine learning neural network to the item point metadata and time series data to determine a similarity between metadata associated with the asset and metadata associated with a known asset type. In this respect, step 804 of method 800 may be substantially similar to step 704 of method 700. The machine learning neural network may particularly include zero-shot learning trained on a plurality of mined triplets each including an anchor input, a positive input, and a negative input, as described herein in connection with FIGS. 2-6. In particular, the machine learning neural network is configured to generate vector representations associated with each of the anchor input, the positive input, and the negative input. A loss function (e.g., prediction workflow 600 of FIG. 6) applied to the vector representations is configured to differentiate between the vector representation associated with the positive input and the vector representation associated with the negative input.

In some embodiments, the machine learning neural network may include a sentence transformer (e.g., sentence transformer 442 of architecture 400 of FIG. 4) configured for transforming the item point metadata data received at step 802. In some embodiments, the machine learning neural network may include a time series transformer (e.g., time series transformer 444 of architecture 400 of FIG. 4) configured for transforming the time series data received at step 802.

In some embodiments, the machine learning neural network may include a feedforward neural network (e.g., FFN 448 of architecture 400) configured for receiving output from the sentence transformer and the time series transformer. In some embodiments, the machine learning neural network may include a layer normalization module (e.g., layer normalization module 452 of architecture 400) configured for receiving output from the feedforward neural network.

With continued reference to FIG. 8, method 800 includes, at step 806, determining that the asset is of the asset type based on the similarity satisfying a predetermined threshold. Step 806 of method 800 may be substantially similar to step 706 of method 700.

With continued reference to FIG. 8, method 800 includes, at step 808, generating a model of the asset in the facility based on the determination of asset type made at step 806. The model (e.g. model 115 of environment 100 of FIG. 1) may include, for example, information related to all assets within the facility and/or all assets connected to a particular building management system (e.g., building management system 165 of environment 100). The model may be displayed on a user device (e.g. any of user devices 105 of environment 100) and utilized to automatically, manually, or semi-automatically manage, maintain, monitor, and control asserts of the facility.

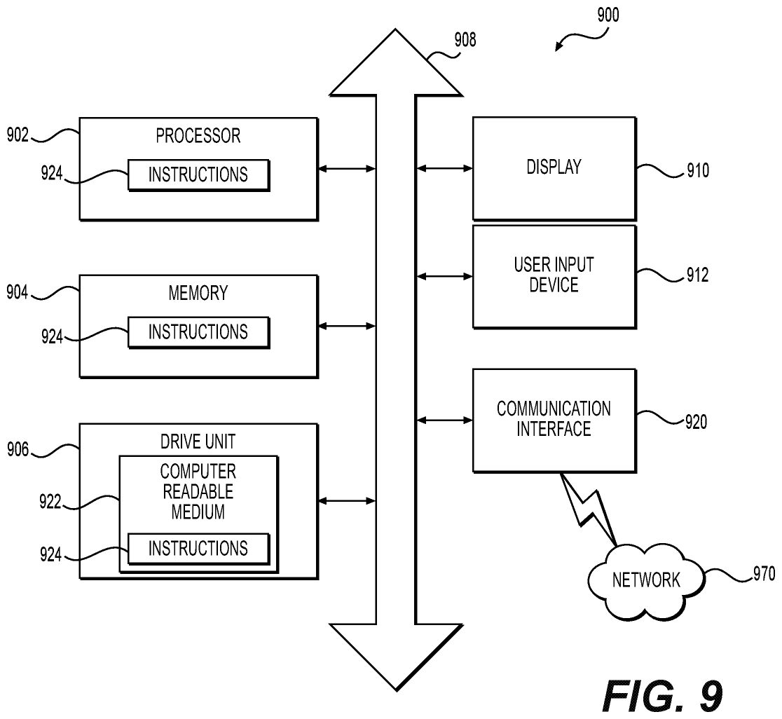

FIG. 9 depicts an implementation of a controller 900 that may execute techniques presented herein, according to one or more embodiments. The controller 900 may include a set of instructions that can be executed to cause the controller 900 to perform any one or more of the methods or computer based functions disclosed herein. The controller 900 may operate as a standalone device or may be connected, e.g., using a network, to other computer systems or peripheral devices.

In a networked deployment, the controller 900 may operate in the capacity of a server or as a client in a server-client user network environment, or as a peer computer system in a peer-to-peer (or distributed) network environment. The controller 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a headset, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 900 can be implemented using electronic devices that provide voice, video, or data communication. Further, while the controller 900 is illustrated as a single system, the term “system” shall also be taken to include any collection of systems or sub-systems that individually or jointly execute a set, or multiple sets, of instructions to perform one or more computer functions.

As illustrated in FIG. 9, the controller 900 may include at least one processor 902, e.g., a central processing unit (CPU), a graphics processing unit (GPU), or both. The processor 902 may be a component in a variety of systems. For example, the processor 902 may be part of a standard computer. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The controller 900 may include a memory 904 that can communicate via a bus 908. The memory 904 may be a main memory, a static memory, or a dynamic memory. The memory 904 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 904 includes a cache or random-access memory for the processor 902. In alternative implementations, the memory 904 is separate from the processor 902, such as a cache memory of a processor, the system memory, or other memory. The memory 904 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 904 is operable to store instructions executable by the processor 902. The functions, acts or tasks illustrated in the figures or described herein may be performed by the processor 902 executing the instructions stored in the memory 904. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 900 may further include a display 910, such as a liquid crystal display (LCD), an organic light emitting diode (OLED), a flat panel display, a solid-state display, a cathode ray tube (CRT), a projector, a printer or other now known or later developed display device for outputting determined information. The display 910 may act as an interface for the user to see the functioning of the processor 902, or specifically as an interface with the software stored in the memory 904 or in the drive unit 906.

Additionally or alternatively, the controller 900 may include an input device 912 configured to allow a user to interact with any of the components of controller 900. The input device 912 may be a number pad, a keyboard, or a cursor control device, such as a mouse, or a joystick, touch screen display, remote control, headset, or any other device operative to interact with the controller 900.

The controller 900 may also or alternatively include drive unit 906 implemented as a disk or optical drive. The drive unit 906 may include a computer-readable medium 922 in which one or more sets of instructions 924, e.g. software, can be embedded. Further, the instructions 924 may embody one or more of the methods or logic as described herein. The instructions 924 may reside completely or partially within the memory 904 and/or within the processor 902 during execution by the controller 900. The memory 904 and the processor 902 also may include computer-readable media as discussed above.

In some systems, a computer-readable medium 922 includes instructions 924 or receives and executes instructions 924 responsive to a propagated signal so that a device connected to a network 970 can communicate voice, video, audio, images, or any other data over the network 970. Further, the instructions 924 may be transmitted or received over the network 970 via a communication port or interface 920, and/or using a bus 908. The communication port or interface 920 may be a part of the processor 902 or may be a separate component. The communication port or interface 920 may be created in software or may be a physical connection in hardware. The communication port or interface 920 may be configured to connect with a network 970, external media, the display 910, or any other components in controller 900, or combinations thereof. The connection with the network 970 may be a physical connection, such as a wired Ethernet connection or may be established wirelessly as discussed below. Likewise, the additional connections with other components of the controller 900 may be physical connections or may be established wirelessly. The network 970 may alternatively be directly connected to a bus 908.

While the computer-readable medium 922 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 922 may be non-transitory, and may be tangible.

The computer-readable medium 922 can include a solid-state memory such as a memory card or other package that houses one or more non-volatile read-only memories. The computer-readable medium 922 can be a random-access memory or other volatile re-writable memory. Additionally or alternatively, the computer-readable medium 922 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 900 may be connected to a network 970. The network 970 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 970 may include wide area networks (WAN), such as the Internet, local area networks (LAN), campus area networks, metropolitan area networks, a direct connection such as through a Universal Serial Bus (USB) port, or any other networks that may allow for data communication. The network 970 may be configured to couple one computing device to another computing device to enable communication of data between the devices. The network 970 may generally be enabled to employ any form of machine-readable media for communicating information from one device to another. The network 970 may include communication methods by which information may travel between computing devices. The network 970 may be divided into sub-networks. The sub-networks may allow access to all of the other components connected thereto or the sub-networks may restrict access between the components. The network 970 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for classifying assets in a facility, the method comprising:
receiving, by at least one processor, item point metadata and time series data associated with an asset;
applying, by at least one processor, a machine learning neural network to the item point metadata and time series data to determine a similarity between metadata associated with the asset and metadata associated with a known asset type; and
determining, by at least one processor, that the asset is of the asset type based on the similarity satisfying a predetermined threshold,
wherein the machine learning neural network comprises anchor-based learning trained on a plurality of mined triplets each including an anchor input, a positive input, and a negative input, wherein the machine learning neural network is configured to generate vector representations associated with each of the anchor input, the positive input, and the negative input, and wherein a loss function applied to the vector representations is configured to differentiate between the vector representation associated with the positive input and the vector representation associated with the negative input.

2. The method of claim 1, wherein the machine learning neural network comprises:
a sentence transformer for transforming the item point metadata; and
a time series transformer for transforming the time series data.

3. The method of claim 2, wherein the neural network further comprises:
a feedforward neural network configured for receiving output from the sentence transformer and the time series transformer; and
a layer normalization module configured for receiving output from the feedforward neural network.

4. The method of claim 1, wherein the machine learning neural network comprises zero shot learning.

5. The method of claim 1, wherein the predetermined threshold at least about 30%.

6. The method of claim 1, further comprising:
receiving, by at least one processor, asset name data associated with the asset,
wherein the neural network comprises an ensemble model.

7. The method of claim 1, further comprising:
generating, by at least one processor, a model of the assets in the facility based on the determination of asset type.

8. A computer system for classifying assets in a facility, the computer system comprising:
at least one memory having processor-readable instructions stored therein; and
at least one processor configured to access the memory and execute the processor-readable instructions, which when executed by the processor configure the processor to perform a plurality of functions, including functions for:
receiving item point metadata and time series data associated with an asset;
applying a machine learning neural network to the item point metadata and time series data to determine a similarity between metadata associated with the asset and metadata associated with a known asset type; and
determining that the asset is of the asset type based on the similarity satisfying a predetermined threshold,
wherein the machine learning neural network comprises anchor-based learning trained on a plurality of mined triplets each including an anchor input, a positive input, and a negative input, wherein the machine learning neural network is configured to generate vector representations associated with each of the anchor input, the positive input, and the negative input, and wherein a loss function applied to the vector representations is configured to differentiate between the vector representation associated with the positive input and the vector representation associated with the negative input.

9. The system of claim 8, wherein the machine learning neural network comprises:
a sentence transformer for transforming the item point metadata; and
a time series transformer for transforming the time series data.

10. The system of claim 9, wherein the neural network further comprises:
a feedforward neural network configured for receiving output from the sentence transformer and the time series transformer; and
a layer normalization module configured for receiving output from the feedforward neural network.

11. The system of claim 8, wherein the machine learning neural network comprises zero shot learning.

12. The system of claim 8, wherein the predetermined threshold at least about 30%.

13. The system of claim 8, wherein the plurality of functions further include functions for:
receiving asset name data associated with the asset,
wherein the neural network comprises an ensemble model.

14. The system of claim 8, wherein the plurality of functions further include functions for:
generating a model of the assets in the facility based on the determination of asset type.

15. A non-transitory computer-readable medium containing instructions for classifying assets in a facility, the non-transitory computer-readable medium storing instructions that, when executed by at least one processor, configure the at least one processor to perform:
receiving item point metadata and time series data associated with an asset;
applying a machine learning neural network to the item point metadata and time series data to determine a similarity between metadata associated with the asset and metadata associated with a known asset type; and
determining that the asset is of the asset type based on the similarity satisfying a predetermined threshold,
wherein the machine learning neural network comprises anchor-based learning trained on a plurality of mined triplets each including an anchor input, a positive input, and a negative input, wherein the machine learning neural network is configured to generate vector representations associated with each of the anchor input, the positive input, and the negative input, and wherein a loss function applied to the vector representations is configured to differentiate between the vector representation associated with the positive input and the vector representation associated with the negative input.

16. The computer-readable medium of claim 15, wherein the machine learning neural network comprises:
a sentence transformer for transforming the item point metadata; and
a time series transformer for transforming the time series data.

17. The computer-readable medium of claim 16, wherein the neural network further comprises:
a feedforward neural network configured for receiving output from the sentence transformer and the time series transformer; and
a layer normalization module configured for receiving output from the feedforward neural network.

18. The computer-readable medium of claim 15, wherein the machine learning neural network comprises zero shot learning.

19. The computer-readable medium of claim 15, wherein the instructions, when executed by at least one processor, configure the at least one processor to further perform:
receiving asset name data associated with the asset,
wherein the neural network comprises an ensemble model.

20. The computer-readable medium of claim 15, wherein the instructions, when executed by at least one processor, configure the at least one processor to further perform:
generating a model of the assets in the facility based on the determination of asset type.
